(19) United States
(12) Patent Application Publication
(10) Pub. No.: US 2014/0062877 A1
(43) Pub. Date: Mar. 6, 2014

(54) DISPLAY APPARATUS AND METHOD OF CONTROLLING THE SAME

(71) Applicant: SAMSUNG ELECTRONICS CO., LTD., Suwon-si (KR)

(72) Inventor: La-ya LEE, Yongin-si (KR)

(21) Appl. No.: 13/904,577

(22) Filed: May 29, 2013

(30) Foreign Application Priority Data
Aug. 31, 2012 (KR) 10-2012-0096715

(51) Int. Cl. G06F 3/0346

(52) U.S. Cl. CPC G06F 3/0346
USPC 345/158

(57) ABSTRACT

A display apparatus is disclosed. The display apparatus includes: a signal reception unit receiving an image signal; a signal processing unit processing the image signal; a display unit displaying an image based on the processed image signal; a communication unit receiving a motion corresponding to an instruction of a user from a remote control unit; and a controller displaying a user directory interface having a predetermined area on the display unit and controlling to perform a function selected among a plurality of functions performed by the display apparatus based on a direction of the motion from the remote control to the user directory interface.

### CROSS-REFERENCE TO RELATED APPLICATION

This application claims priority from Korean Patent Application No. 10-2012-0096715, filed on Aug. 31, 2012 in the Korean Intellectual Property Office, the disclosure of which is incorporated herein by reference in its entirety.

### BACKGROUND

1. Field

Apparatuses and methods consistent with the exemplary embodiments relate to a display apparatus and a method of controlling the same, more particularly to a display apparatus providing an intuitive user directory interface to a user, and a method of controlling the same.

2. Description of the Related Art

A display apparatus, such as a digital TV, provides an interface for a user to save a favorite channel or program or a frequently used function into a preference list.

However, an interface of a conventional display apparatus inconveniently involves a plurality of stages to set a preference list, or does not allow a user to actively manipulate the interface as they wish, only enabling passive use of the interface.

### SUMMARY

An aspect of one or more exemplary embodiments is to provide a display apparatus providing a user interface to enable a user to intuitively and easily add, delete, and change a favorite function using a touch-based remote control, and a method of controlling the same.

The foregoing and/or other aspects may be achieved by providing a display apparatus including: a signal receiver configured to receive an image signal; a signal processor configured to process the image signal; a display unit which displays an image based on the processed image signal; a communicator configured to receive a motion corresponding to an instruction of a user from a remote control; and a controller configured to display a interface having an area on the display unit and control to perform a function selected among a plurality of functions performed by the display apparatus based on a direction of the motion, the direction of the motion being relative to the interface.

The motion may include at least one from among a motion in an entering direction to the interface, a motion in an exit direction from the interface, and a motion within the region of the interface.

The region of the interface may include a region in which items corresponding to the plurality of functions are listed and displayed.

The items may be displayed as a thumbnail obtained by capturing the image being displayed on the display unit.

The items may be displayed as a thumbnail corresponding to the image being displayed on the display unit provided by a broadcasting company.

The items may be displayed as an icon corresponding to a selectable menu.

The items may be added, deleted, or changed on the interface based on the direction of the motion.

The motion may include at least one from among touching, drawing, throwing, and tilting on the remote control.

The interface may be displayed on the display unit based on the touching on the remote control.

The interface may disappear after a predetermined time.

The interface may be displayed in a translucent style, overlapping the image displayed on the display unit.

The display apparatus may further include a storage, wherein the storage stores information on the selected function.

The foregoing and/or other aspects may be achieved by providing a method of controlling an apparatus including: displaying an interface having an area on a display unit; receiving input of a motion corresponding to an instruction of a user from a remote control unit; and controlling to perform a function selected among a plurality of functions performed by the apparatus based on a direction of the motion, the direction being relative to the interface.

The motion may include at least one from among a motion in an entering direction to an interface, a motion in an exit direction from the interface, and a motion within the region of the interface.

The region of the interface may include a region in which items corresponding to the functions are listed and displayed.

The items may be displayed as a thumbnail obtained by capturing the image being displayed on the display unit.

The items may be displayed as a thumbnail corresponding to the image being displayed on the display unit provided by a broadcasting company.

The items may be displayed as an icon corresponding to a selectable menu.

The items may be added, deleted, or changed on the user interface based on the direction of the motion.

The motion may include at least one from among touching, drawing, throwing, and tilting on the remote control unit.

The interface may be displayed on the display unit corresponding to the touching on the remote control unit.

The interface may disappear after a predetermined time.

The user interface may be displayed in a translucent style, overlapping the image displayed on the display unit.

The method may further include storing information on the selected function.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram of a display apparatus according to an exemplary embodiment.

FIG. 2 schematically illustrates that an image being displayed on the display apparatus is added to a user directory interface as an item in a thumbnail form by inputting a motion to a remote control unit according to an exemplary embodiment.

FIG. 3 schematically illustrates that a menu displayed on the display apparatus is added to the user directory interface as an item in an icon by inputting a motion to the remote control unit according to an exemplary embodiment.

FIG. 4 schematically illustrates that a function corresponding to an item listed on the user directory interface is executed by inputting a motion to the remote control unit according to an exemplary embodiment.

FIG. 5 schematically illustrates that an item listed on the user directory interface is deleted by inputting a motion to the remote control unit according to an exemplary embodiment.

FIG. 6 schematically illustrates that a selection is made among the items listed on the user directory interface by inputting a motion to the remote control unit according to an exemplary embodiment.

FIG. 7 is a flowchart illustrating a method of controlling a display apparatus according to an exemplary embodiment.

### DETAILED DESCRIPTION OF EXEMPLARY EMBODIMENTS

Hereinafter, exemplary embodiments will be described in detail with reference to accompanying drawings.

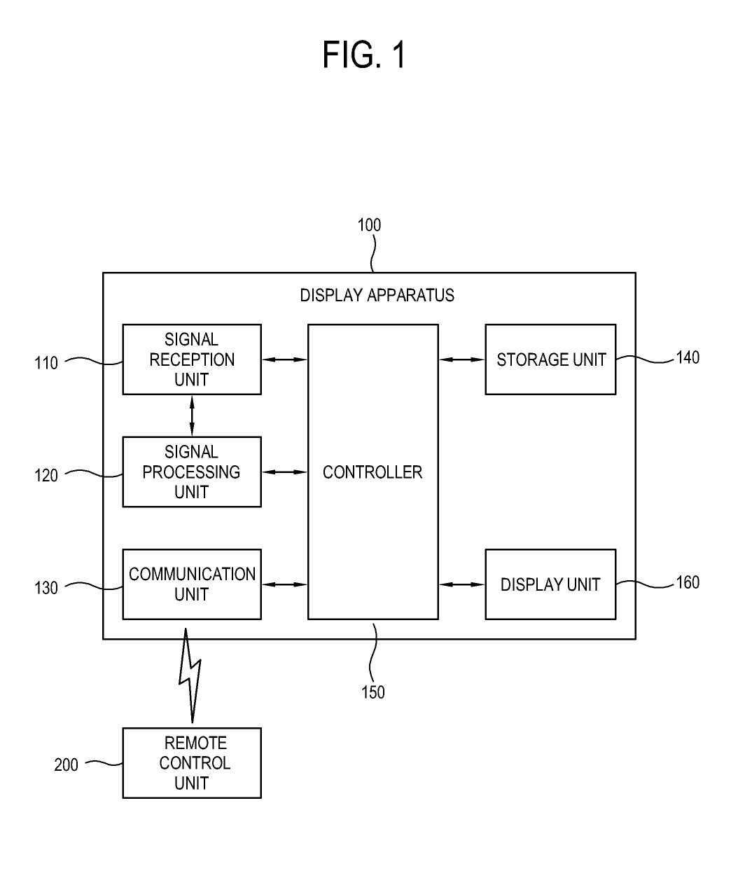

FIG. 1 is a block diagram of a display apparatus according to an exemplary embodiment.

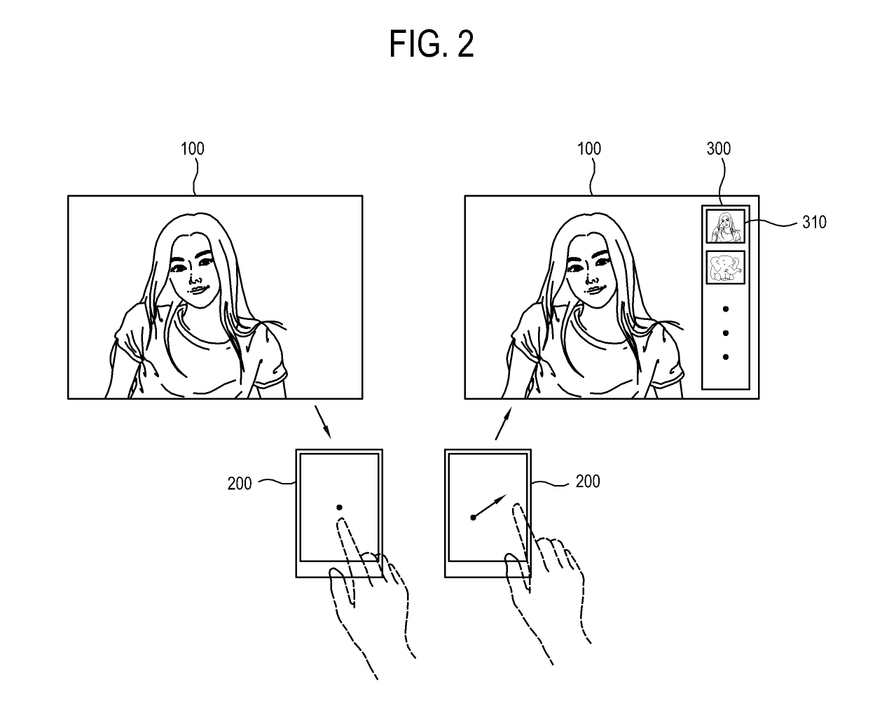

As shown in FIG. 1, the display apparatus 100 according to the present exemplary embodiment includes a signal reception unit 110 receiving an image signal, a signal processing unit 120 processing the image signal, a display unit 160 displaying an image based on the processed image signal, a communication unit 130 receiving an instruction corresponding to a motion from a remote control unit 200, and a controller 150 displaying a user directory interface 300 (shown in FIG. 2) having a predetermined area on the display unit 160 and controlling the user directory interface 300 so that a user desired function is selectively displayed on the user directory interface 300 among functions performed by the display apparatus 100 based on a direction of the motion from the remote control unit 200 to the user directory interface 300. The controller may include a central processing unit (CPU) or processor core configured to perform the functions and/or operations of the controller as described herein.

In the present exemplary embodiment, the display apparatus 100 may be provided as a digital television (DTV) capable of receiving and displaying a broadcast signal from a broadcasting station, without being limited thereto.

The signal reception unit 110 receives an image signal, such as a broadcast signal, from the outside.

The signal processing unit 120 processes the image signal received from the outside to be displayed on the display unit 160.

The communication unit 130 receives an instruction from the remote control unit 200.

The display unit 160 receives the image signal processed by the signal processing unit 120 to display an image.

The controller 150 displays the user directory interface 300 having the predetermined area on the display unit 160 in accordance with an instruction transmitted from the remote control unit 200 through the communication unit 130 and controls the user directory interface 300 so that a user desired function is selectively displayed on the user directory interface 300 among functions performed by the display apparatus 100 based on a direction of a motion from the remote control unit 200 to the user directory interface 300.

The remote control unit 200 receives input of a user motion in touch mode and transmits the input to the communication unit 130 of the display apparatus. The user may input a motion, such as touching, drawing, throwing, and tilting, through the remote control unit 200. In addition, the motion may include any motion to be input according to an intuitive instruction given by the user.

The user directory interface 300 may be displayed in a region of the display unit 130, overlapping an image currently displayed on the display unit 130, when the user touches the remote control unit 200. The user directory interface 300 may list items 310, such as a broadcast of a user favorite channel, a particular channel, and a menu. Such items correspond to functions to be performed by the display apparatus 100 and may be displayed as a thumbnail obtained by capturing an image being displayed on the display unit 160, a thumbnail corresponding to a program being displayed on the display unit 160 provided by a broadcasting company, or an icon corresponding to a selectable menu. The user inputs a motion through the remote control unit 200, thereby adding, deleting, or changing such items on the user directory interface 300. Adding, deleting or changing these items are realized in accordance with the direction of the motion input by the user through the touch-based remote control unit 200. The direction may include an entering direction to the user directory interface 300, an exit direction from the user directory interface 300, and a moving direction within the region of the user directory interface 300 based on the displayed user directory interface 300.

For example, the items 310 corresponding to a user's favorite functions to be performed by the display apparatus 100 may be added, deleted or changed as follows.

FIG. 2 schematically illustrates that an image being displayed on the display apparatus is added to the user directory interface as an item in a thumbnail form by inputting a motion to the remote control unit according to an exemplary embodiment.

Referring to FIG. 2, the user may immediately add a channel currently viewed to the user directory interface 300 as a thumb nail using a touch-and-draw method supported by the touch-based remote control unit 200. Applying a touch-and-draw method to the touch-based remote control unit 200 may include touching the display of the remote control unit and moving a finger while maintaining contact with the display of the remote control unit. When the user wishes to add a currently viewed channel to the user directory interface 300, the user lightly touches the touch-based remote control unit 200. Then, the user directory interface 300 appears with a predetermined area on the display unit 160 of the display apparatus 100. Here, the user directory interface 300 may be disposed on any side among four sides of the display unit 160. In the present exemplary embodiment, the user directory interface 300 is displayed with a predetermined area on a right side of the display unit 160, overlapping, in a translucent style, a currently displayed image. However, the user directory interface 300 may be provided in an opaque form or to be adjusted in transparency, without being limited to the translucent style. While the user directory interface 300 is displayed, the user touches and draws the current channel through the remote control unit 200 to input the motion as described above, for example, moving an image being displayed according to the current channel on the display unit 160 in an entering direction to the user directory interface 300 or a moving direction within the region of the user directory interface 300, thereby inputting an instruction to add the current channel to the user directory interface 300. Then, a thumbnail 310 corresponding to the channel is added to and registered in the user directory interface 300. Likewise, to register a different channel in the user directory interface 300 after turning in to the channel, the user may add the channel as a next item 310 of the user directory interface 300 through touch-and-draw input using the remote control unit 200. As described above, the thumbnail 310 may be obtained by capturing a program of a selected current channel or provided by a broadcasting company.

Meanwhile, a function of the display apparatus 100 added to the user directory interface 300, that is, an item, is not limited to a broadcast or a channel currently displayed. In addition to the broadcast or channel, the user may add a menu corresponding to a frequently used function supported by the display apparatus 100 to the user directory interface 300 as a shortcut icon using the touch-based remote control unit 200.

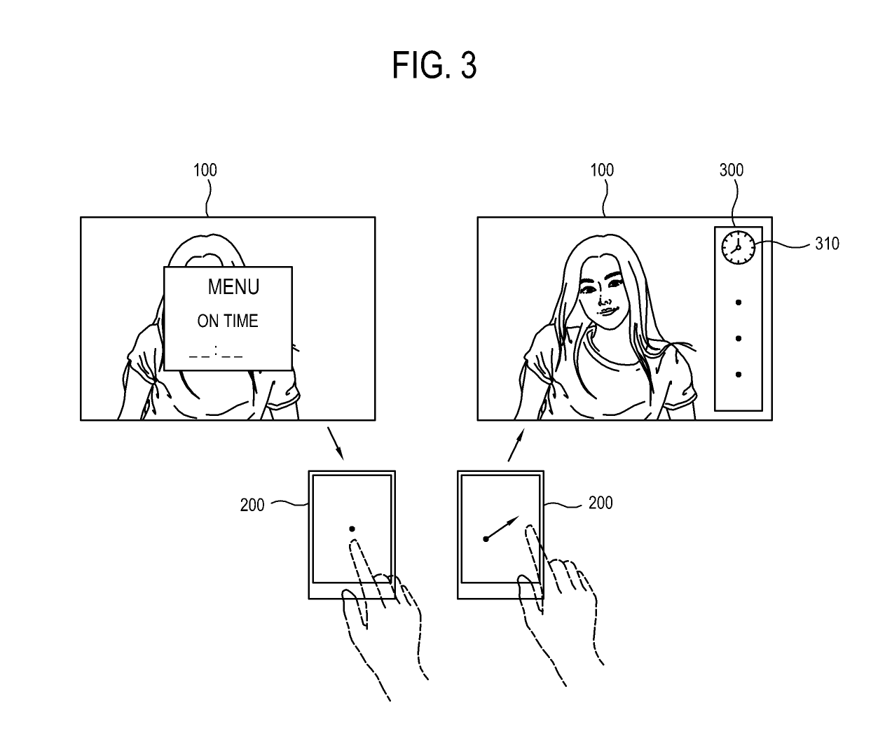

FIG. 3 schematically illustrates that a menu displayed on the display apparatus 100 is added to the user directory interface 300 as an item in the form of icon by inputting a motion to the remote control unit 200 according to an exemplary embodiment.

Likewise in an operation of adding a broadcast or a channel, the user may immediately add a menu corresponding to a function of the display apparatus 100 to the user directory interface 300 as an item 310 in the form of an icon using the touch-and-draw method supported by the touch-based remote control unit 200. When the user frequently uses a morning wake-up call function on the menu corresponding to the function of the display apparatus 100, the user may register the morning wake-up call function in the user directory interface 300. A conventional morning wake-up call function is set via menu, setting, time, and morning call stages. However, in the present embodiment, the user draws a morning wake-up call item on the menu, which is being activated, to the user directory interface 300 using the touch-based remote control device 200, thereby easily registering an icon 310 corresponding to the morning wake-up call in the user directory interface 300 and conveniently running the morning wake-up call by presenting the user directory interface 300 in which the morning wake-up call item 310 is registered as necessary.

As described above, items 310, for example, a channel, a broadcast, and a morning wake-up call function, added and registered in the user directory interface 300 appear again, when the user touches the touch-based remote control unit 200, and disappear after a predetermined time so as not to disturb viewing the display apparatus. This method is even more convenient than a conventional method of adding a channel to a favorite list and changing to the channel among favorite channels registered in advance or finding an item from a menu and directly accessing the item, and, additionally, provides the user with fun activity.

Meanwhile, the display apparatus 100 according to the present exemplary embodiment may further include a storage unit 140. The storage unit 140 may store setting information on the user directory interface 300 and the functions of the display apparatus 100 registered in the user directory interface 300.

The functions of the display apparatus 100 registered in the user directory interface 300 are executed as follows.

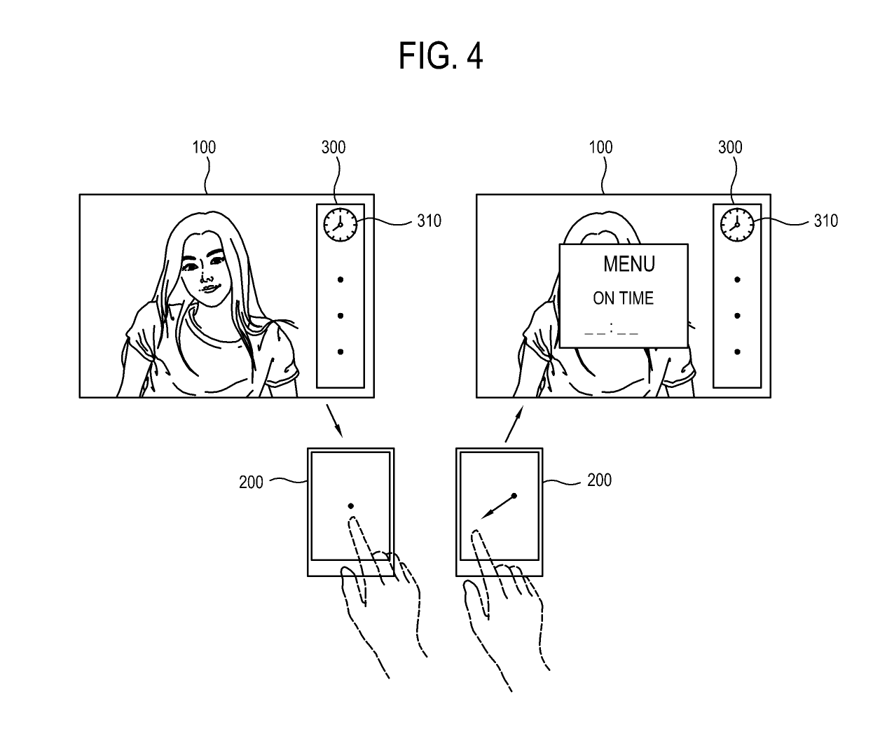

FIG. 4 schematically illustrates that a function corresponding to an item 310 listed on the user directory interface 300 is executed by inputting a motion to the remote control unit 200 according to an exemplary embodiment.

Referring to FIG. 4, to immediately execute the function 310 registered in the user directory interface 300, the user, the user touches the selected item using the touch-based remote control unit 200 and draws the item from the user directory interface 300 in a direction toward a center of a screen, that is, an opposite direction to a draw direction when adding and registering an item, thereby simply executing the function. That is, the user inputs a touch-and-draw motion using the touch-based remote control unit 200, thereby easily executing the functions 310 registered in the user directory interface 300.

Likewise, when the user wishes to change between the channels 310 registered in the user directory interface 300, the touch-and-draw method may be also used to easily change to a channel. In detail, the user selects a new channel by touching the remote control unit 200 and draws the channel in the direction toward the center of the screen, thereby changing to the channel.

Further, the functions of the display apparatus 100 which are registered in the user directory interface 300 may be deleted as follows.

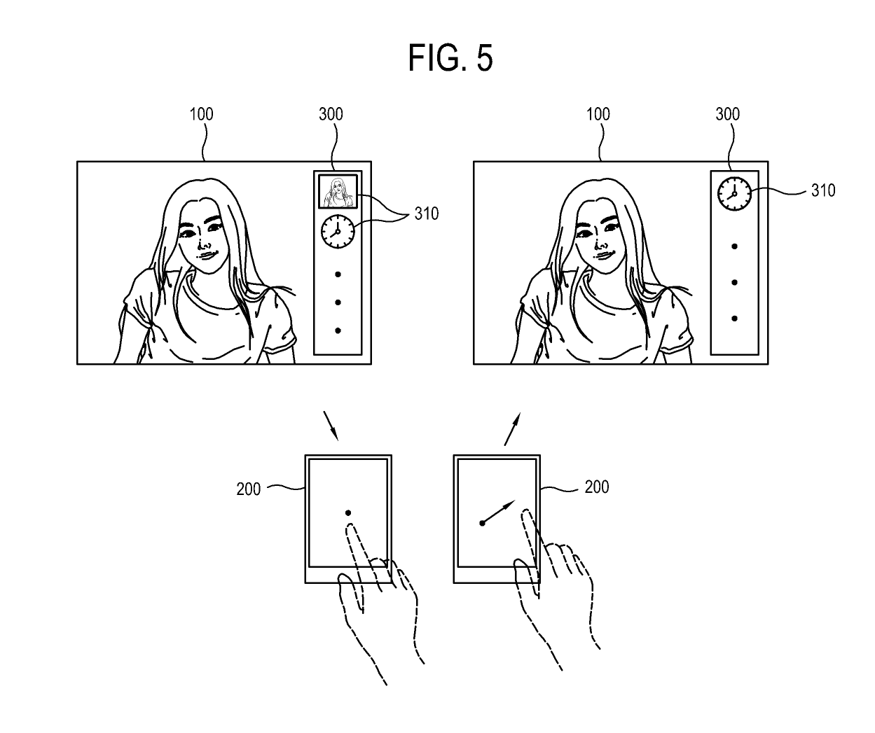

FIG. 5 schematically illustrates that the item 310 listed on the user directory interface 300 is deleted by inputting a motion to the remote control unit 200 according to an exemplary embodiment.

Referring to FIG. 5, to delete a registered item from the user directory interface 300, the user touches a selected item using the touch-based remote control unit 200 and throws the item from the user directory interface 300, in an outward direction, that is, an opposite direction to the direction toward the center of the screen, thereby easily deleting the item. That is, the user inputs a touch-and-throw motion using the touch-based remote control unit 200, thereby easily deleting the functions 310 registered in the user directory interface 300.

Further, the functions of the display apparatus 100 registered in the user directory interface 300 may be changed as follows.

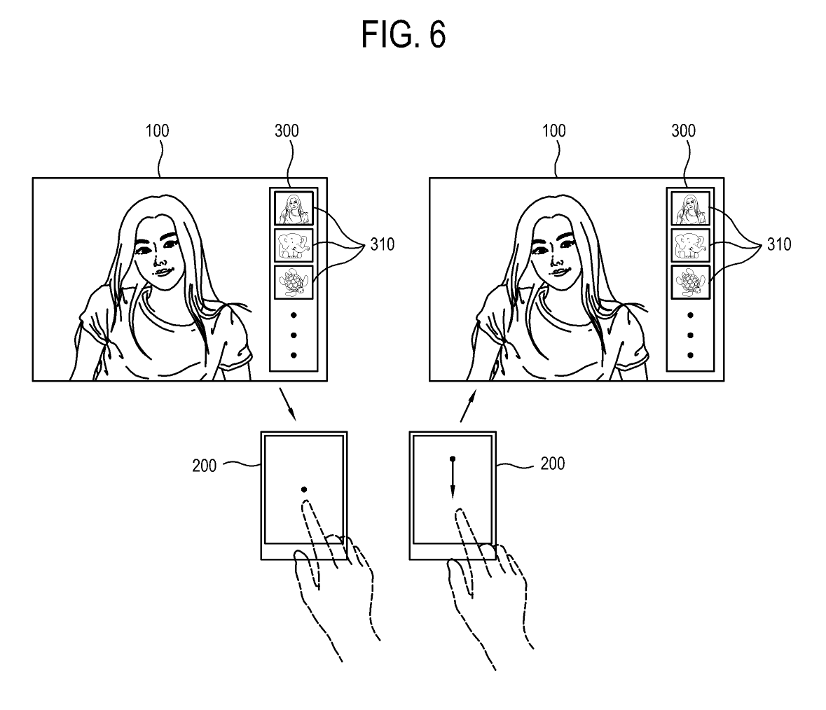

FIG. 6 schematically illustrates that a selection is made among the items 310 listed on the user directory interface 300 by inputting a motion to the remote control unit 200 according to an exemplary embodiment.

Referring to FIG. 6, when the user directory interface 300 is displayed in a long bar vertically on a left or right side of the display unit 160, the user may select one of the registered items by drawing up and down within the user directory interface 300 using the touch-based remote control unit 200. Alternatively, the user directory interface 300 is displayed in a long bar horizontally on an upper or lower side of the display unit 160, the user may selects one of the registered items by drawing right and left within the user directory interface 300 using the touch-based remote control unit 200.

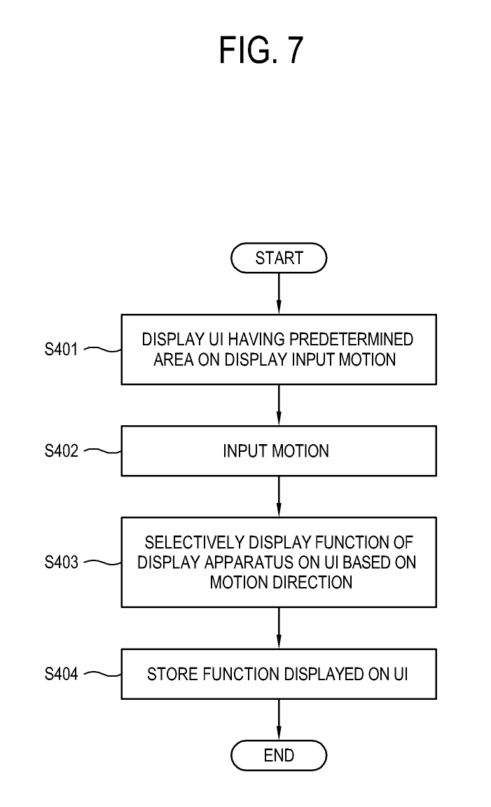

FIG. 7 is a flowchart illustrating a method of controlling a display apparatus according to an exemplary embodiment.

According to the method according to the present exemplary embodiment, a user directory interface having a predetermined area is displayed on the display unit when a touch input of the user is received through the touch-based remote control unit (S401). When a motion of the user is input through the remote control unit (S402) while the user directory interface having the predetermined area is displayed on the display unit, a function of the display apparatus is selectively displayed on the user directory interface based on a direction of the motion, that is, the function is added, deleted, or changed (S403). Then, the function displayed on the user directory interface is stored (S404).

As described above, according to one or more exemplary embodiments, a user may generate and manage a desired favorite list. Above all, the user may be provided with an intuitive user directory interface, thereby actively managing the list.

Further, the user registers, changes, and deletes a program and registers frequently used functions as a list through the user directory interface, thereby enabling quick access to the functions.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An apparatus comprising:
a signal receiver configured to receive an image signal;
a signal processor configured to process the image signal;
a display unit which displays an image based on the processed image signal;
a communicator configured to receive a motion corresponding to an instruction of a user from a remote control; and
a controller configured to display an interface having an area on the display unit and control to perform a function selected among a plurality of functions performed by the apparatus based on a direction of the motion, the direction of the motion being relative to the interface.

2. The apparatus of claim 1, wherein the motion comprises at least one from among a motion in an entering direction to the interface, a motion in an exit direction from the interface, and a motion within the region of the interface.

3. The apparatus of claim 1, wherein the region of the interface comprises a region in which items corresponding to the plurality of functions are listed and displayed.

4. The apparatus of claim 3, wherein the items are displayed as a thumbnail obtained by capturing the image being displayed on the display unit.

5. The apparatus of claim 3, wherein the items are displayed as a thumbnail corresponding to the image being displayed on the display unit provided by a broadcasting company.

6. The apparatus of claim 3, wherein the items are displayed as an icon corresponding to a selectable menu.

7. The apparatus of claim 1, wherein the items are added, deleted, or changed on the interface based on the direction of the motion.

8. The apparatus of claim 1, wherein the motion comprises at least one from among touching, drawing, throwing, and tilting on the remote control.

9. The apparatus of claim 8, wherein the interface is displayed on the display unit based on the touching on the remote control.

10. The apparatus of claim 8, wherein the interface disappears after a predetermined time.

11. The apparatus of claim 8, wherein the interface is displayed in a translucent style, overlapping the image displayed on the display unit.

12. The apparatus of claim 1, further comprising a storage, wherein the storage stores information on the selected function.

13. A method of controlling an apparatus comprising:
displaying an interface having an area on a display unit;
receiving input of a motion corresponding to an instruction of a user from a remote control unit; and
controlling to perform a function selected among a plurality of functions performed by the apparatus based on a direction of the motion, the direction being with respect to the interface.

14. The method of claim 13, wherein the motion comprises at least one from among a motion in an entering direction to an interface, a motion in an exit direction from the interface, and a motion within the region of the interface.

15. The method of claim 13, wherein the region of the interface comprises a region in which items corresponding to the functions are listed and displayed.

16. The method of claim 15, wherein the items are displayed as a thumbnail obtained by capturing the image being displayed on the display unit.

17. The method of claim 15, wherein the items are displayed as a thumbnail corresponding to the image being displayed on the display unit provided by a broadcasting company.

18. The method of claim 15, wherein the items are displayed as an icon corresponding to a selectable menu.

19. The method of claim 13, wherein the items comprise one from among added, deleted, and changed on the interface based on the direction of the motion.

20. The method of claim 19, wherein the motion comprises at least one from among touching, drawing, throwing, and tilting on the remote control unit.

21. The method of claim 20, wherein the interface is displayed on the display unit corresponding to the touching on the remote control unit.

22. The method of claim 21, wherein the interface disappears after a predetermined time.

23. The method of claim 21, wherein the interface is displayed in a translucent style, overlapping the image displayed on the display unit.

24. The method of claim 13, further comprising storing information on the selected function.
